(19) United States
(12) Patent Application Publication
(10) Pub. No.: US 2003/0191856 A1
(43) Pub. Date: Oct. 9, 2003

(54) Wireless networking with dynamic load sharing and balancing

(76) Inventors: Paul Lewis, Indialantic, FL (US); Jeffrey J. Conley, Boca Raton, FL (US)

Correspondence Address: J. Rodman Steele, Jr., Akerman, Senterfitt & Eidson, P.A., P.O. Box 3188, West Palm Beach, FL, 33402-3188, US

(21) Appl. No.: 10/118,058

(22) Filed: Apr. 8, 2002

(51) Int. Cl. G06F 15/173; H04Q 7/00

(52) U.S. Cl. 709/241; 370/328

(57) ABSTRACT

A dynamic load sharing and balancing system for a wireless network (100) coupled to a wired network (20) includes a network router (40) for coupling a plurality of wired network paths (20) and for providing status information for the plurality of wired network paths and a plurality of broadband radios (26 and 46) forming a plurality of radio frequency paths and for providing status information for each of the plurality of radio frequency paths. The system further comprises a network arbitration module (32) for receiving the status information from the plurality of wired network paths and for receiving the status information from at least one of the plurality of radio frequency paths and for directing traffic among the plurality of radio frequency paths based on the status information from the wired network paths and the plurality of radio frequency paths.

### BACKGROUND OF THE INVENTION

1. Field of Invention

The present invention is directed generally to an apparatus and method that decreases latency while increasing overall network efficiency and performance, and more specifically to a method and apparatus for dynamic load sharing and balancing for a wireless network coupled to a wired network.

2. Description of the Related Art

Wireless local area networks (WLAN) are becoming a more prevalent alternative for deploying high speed data due to their many advantages including the ability to deploy them in a number of network topologies. The simplest arrangement is to connect two networks together with a pair of single channel radio transceivers, where the digital data modulates a single frequency carrier signal. To provide network security, processing gain and frequency reuse, the radio transceivers can employ either frequency hopping or direct sequence spread spectrum protocols. Currently available WLAN technology provides an aggregate bandwidth of up to 1 gigabit within a ten-mile radius.

Frequency Hopping spread spectrum (FHSS) technology uses a narrow band carrier that changes frequency in a pattern known to both the radio transmitter and receiver. Properly synchronized, the receiver can follow the frequency hops initiated by the transmitter and stay locked on to the transmitted signal. To the unintended receiver, the frequency-hopping signal appears as short duration impulse noise. Direct-sequence spread spectrum (DSSS) technology generates a redundant bit pattern for each information data bit to be transmitted. This bit pattern is referred to as a chip (chipping code). The longer the chip, the greater the probability that the original data can be recovered and the greater the bandwidth required to transmit the signal. In the event that one or more bits in the chip are corrupted during the transmission, error-correcting techniques embedded in the signal can allow recovery of the original data without the need for retransmission. To the unintended receiver, a DSSS signal appears as low power wideband noise and thus it is rejected by the narrow band receiver.

A WLAN can be implemented within a building, on a campus, or across a metropolitan area. An RF signal is utilized to connect the various sites in lieu of the traditional wired approach. The throughput facilitated by a wireless network can be easily expanded, as compared with a wired network, by upgrading the transmitters and receivers in the network. Data encryption can also be provided as an additional level of security, beyond that provided by the FHSS transmission protocol. Since it is not physically hard wired, a wireless network can be easily reconfigured as required when additional sites need to be added, changed or moved. If a site is moved, the antenna is reappointed to create the new path and the new link is established.

Due to the use of frequency hopping or direct spread sequence protocols, multiple radio transceivers can be used within the same geographical area and each receiver will be able to identify and demodulate the appropriate transmitted signal. This identifying characteristic is due to the unique frequency hopping or direct spread sequence codes. This technique is commonly referred to as code division multiplexing.

In a typical WLAN configuration, in a building or on a campus, a transceiver is located at a fixed access point, which is connected to the wired network, the internet or the Public Switched Telephone Network (PSTN), typically using an Ethernet cable connection. The access point radio receivers buffer and transmit data between the WLAN and the wired network infrastructure. An access point can support a number of wireless users and can function within a range of several hundred feet to several miles. The antenna at the access point is usually mounted above the terrain to ensure maximum signal strength and coverage. End users access to the WLAN access point is connected via a computer network interface card (NIC), whereby their local area network (LAN) is connected typically by Ethernet cable to the radio transceiver. Once this network is established the network acts as it would on any LAN.

As implemented in a wide area network (WAN) or metropolitan area network (MAN), a wireless network takes on a slightly different configuration. In particular, access to the wireless network is provided by a main distribution point communicating via an RF signal with individual access points located throughout the metropolitan geographic area. In turn, these access points communicate via radio transceiver directly with individual customers. At the customer site, the radio transceiver communicates with a computer or with a hub server that may in turn communicate with other individual computers. In the latter case, individual computers are connected to the hub server for transmitting and receiving information. For example, an individual user requests access to the internet as follows: From the individual's computer at a customer site, the digital data representing that request is sent to the server where it modulates a carrier signal and is then transmitted from that customer site to the nearest access point, typically using either a frequency hopping or direct sequence spread protocol. From the access point, the request is transmitted through the RF link to the main distribution point. There the request is received by a radio transceiver and fed to a hard wired based connection to the internet. In response to the user request, data is transmitted in the reverse direction through the same radio transceiver links. Depending upon the characteristics of the transceivers at each site, throughput of 64 kbps to 10 mbps is typically available.

In the MAN configuration, each access point including the main distribution point employs the necessary hardware and software elements to dynamically reconfigure each of the links so the throughput is properly allocated among the users. In some circumstances, individual users are guaranteed a committed level of throughput and the access point allocates the appropriate level of throughput to meet that commitment.

The benefits of a WLAN are well documented and many competent suppliers manufacture such radio technology. In addition to being hard wired to the WLAN, users can access shared information through the WLAN without a physical place to “plug in” within a predetermined range. Therefore, the wireless portion of the network can be easily setup or modified without installing or moving wires across in building or across a geographic area. The RF signals used in a WLAN can penetrate walls and the radio transmitter power and receiver sensitivity will determine the actual signal strength and coverage area. Typical throughput data rates range from 64 Kbps to 10 Mbps with the actual throughput determined by network traffic congestion (the amount of simultaneous users) and the propagation factors such as distance from the access point, multi-path interference and latency in the hard wired portion of the network access.

One of the inevitable limitations associated with all networks are the throughput capacity constraints. All networks have maximum throughput limitations which can limit capacity on the network at some point. Eventually, a network at or very near its maximum capacity will slow and network efficiency will greatly diminish. Therefore, users will see a reduced rate in information exchange across the network. Data transfer rates in a wireless network are determined by several factors, including network topology, morphology, RF modulation scheme, infrastructure equipment layout, user demand as a percentage of overall capacity, and the latency throughout the network including the internet. Networks were designed for users to share data on a common platform. Therefore, many users will utilize the network simultaneously, which places peak demand on the overall capacity. For instance, in a simple network usage, all users would get equal rights to the network and therefore, the network would not be able to accommodate as many subscribers. This is unreasonable and a costly waste of network resources as most users are not placing high demand on a regular basis across the network. Therefore, networks must be managed by user, by application and by contracted throughput requirements. For example, a user that requests a streaming video clip can be given a higher priority and a user that is sending an email which would remain at a lower priority. This allows networks to accommodate more users while providing the throughput that they contracted for.

Currently, there are no WLAN or wireless networked systems that arbitrate the wired traffic demands and throughput along with the wireless traffic demands and throughput in an efficient and effective manner. There maybe systems that arbitrate traffic and throughput in the wired space and systems that arbitrate traffic and throughput in the wireless arena respectively, but none that effectively integrate both. Thus, a need exists for a system and method of dynamic load sharing and balancing a wireless network and a wired network accounting for latency and loading patterns that may be experienced in either the wireless or wired network.

### SUMMARY OF INVENTION

The present invention advantageously overcomes the throughput limitations present in the relevant art by employing a dynamic load sharing (DLS) and a dynamic load balancing (DLB) scheme to help better manage network traffic demand and minimize network latency while providing redundant routes thereby maximizing network uptime. By implementing the DLS and DLB scheme, data is routed in a manner that maximizes network efficiency and uptime by managing 2 or more possible wireless routes between a customer and a network source or data information source. By minimizing throughput latency between the customer and the data information source, a network arbitration module can now dynamically determine the best, least congested route from the customer to the information source. As applied to the present invention, if the DLS and DLB are implemented at a main distribution point (MDP) or a metropolitan distribution point, for instance, then the customer will enjoy a substantial improvement in the up-time and consistent network performance.

Other WLAN networks have single points of failure which not only limit the uptime of the network, but create bottlenecks and congestion in the route from a customer to the network source. The present invention not only provides multiple routes, but constantly measures, in real time, the performance of each route and utilizes the least congested route thereby transporting information more efficiently. Should a failure occur in a route, an embodiment in accordance with the present invention will detect this, route around the trouble and issue a major network alarm identifying the problem.

In a first aspect of the present invention, a network arbitration module for directing data traffic in a wireless network and a wired network comprises at least a first input for receiving status information from at least a first network broadband radio and at least a second input for receiving status information from a wired network router. The module further comprises a processor programmed to control an antenna route switch for coupling at least the first network broadband radio among a plurality of wireless network paths.

In a second aspect of the present invention, a network arbitration module for directing data traffic in a wireless network and a wired network comprises at least a first input for receiving status information from a plurality of broadband radio paths, at least a second input for receiving status information from a wired network router, and a processor. The processor is preferably programmed to control an antenna route switch for coupling at least a first network broadband radio among the plurality of broadband radio paths forming a plurality of wireless network paths.

In a third aspect of the present invention, a dynamic load sharing and balancing system for a wireless network coupled to a wired network comprises a network router for coupling a plurality of wired network paths and for providing status information for the plurality of wired network paths and a plurality of broadband radios forming a plurality of radio frequency paths and for providing status information for each of the plurality of radio frequency paths. The system further comprises a network arbitration module for receiving the status information from the plurality of wired network paths and for receiving the status information from each of the plurality of radio frequency paths and for directing traffic among the plurality of radio frequency paths based on the status information from the wired network paths and each of the plurality of radio frequency paths.

In a fourth aspect of the present invention, a method of dynamic load sharing and balancing for a wireless network coupled to a wired network comprises the steps of receiving status information for a plurality of wired network paths and for each of a plurality of radio frequency paths. The method further comprises the step of arbitrating connections among the plurality of wired network paths and the plurality of radio frequency paths based on the status information received from each of the plurality of radio frequency paths and the status information received from the wired network paths.

### BRIEF DESCRIPTION OF THE DRAWINGS

The present invention can be more easily understood and the further advantages and uses thereof more readily apparent, when considered in view of the description of the preferred embodiments and the teachings of the present invention as compared to the current art.

FIG. 1 is a block diagram of a wireless local area network system detailing the flow of such a typical network.

FIG. 2 is a block diagram of a wireless network system utilizing a network arbitration module in accordance with the present invention.

FIG. 3 is another block diagram detailing the flow of the wireless network system and in particular the function of the Network Arbitration Module as utilized in FIG. 2 illustrating the broadband internet and IP data access to and from the network source in accordance with the present invention.

FIG. 4 is a block diagram detailing the flow and interaction of the Network Arbitration Module (NAM) with other key components in the wired and wireless network in accordance with the present invention.

FIG. 5 is a flow chart illustrating a method of dynamic load sharing and balancing for a wireless network coupled to a wired network in accordance with the present invention.

### DETAILED DESCRIPTION OF THE PREFERRED EMBODIMENTS

SEQUIL Corporation has created a new and innovative approach to solving access problems in the local loop arena by creating a unique technology called Dynamic Wavelength Multiple Access (DWMA). DWMA uses a mixture of proven network technical advances and integrates them into an integrated network architecture whereby the network can be a hybrid mixture of wireless and fiber technology deploying IP networks using the very proven and stable Ethernet protocol. Of course, the present invention as recited in the claims can have broader application to any wireless and wired hybrid network combination.

With DWMA, a network infrastructure can enjoy the stability and benefits of a modern fiber network while also fully taking advantage of the added speed and flexibility of a broadband wireless network and its deployment capability. The DWMA technology enables the design of dependable and reliable networks that are flexible in many ways. Because the basic premise of the network of the present invention is “a transport deployment” strategy, it is not critical to be limited by any particular communication frequency or technology which enables such a system to be flexible and somewhat technology agnostic. The wireless portion can utilize either licensed and/or license exempt frequencies and the radio equipment can come from several “best of breed” suppliers.

The DWMA invention is directed in general to an apparatus that uses methods, software and/or hardware to decrease the latency times while increasing overall network efficiency and performance in information retrieval and exchange, and more specifically to a method and apparatus for decreasing latency in a wireless network.

Prior to describing in detail the particular Broadband internet and IP data access network associated with the present invention, it should be observed that the present invention resides primarily in a novel combination of steps, other apparatus, including software and firmware related to transporting and routing high speed data such as broadband internet and IP data dynamically in a wireless access network. Accordingly, the hardware components and method steps have been represented by conventional elements in the drawings, showing only those details that are pertinent to the present invention so as not to obscure the disclosure with details that will be readily apparent to those skilled in the art and having the benefit of the description herein.

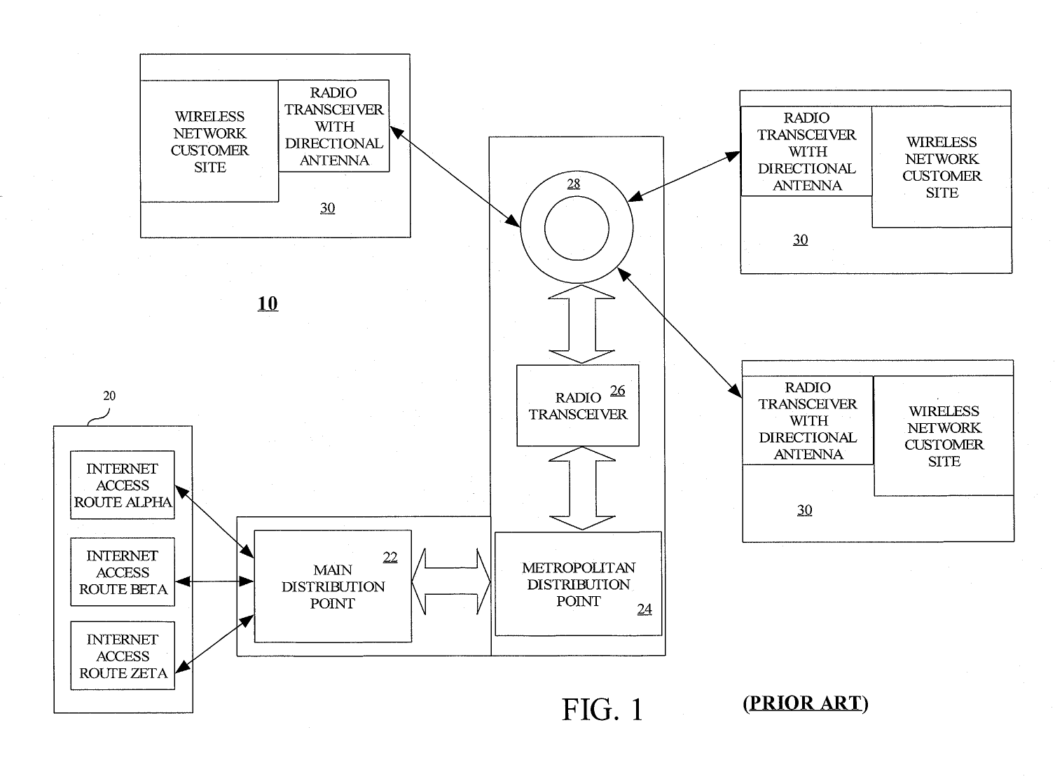

FIG. 1 comprises a block diagram detailing the flow of a typical or conventional wireless network 10 (current art). A network information source 20 is depicted here as the internet traffic source. The purpose of the wireless network 1 0 is to provide connectivity between a plurality of customers located at disparate geographical points to the internet (20) via a wireless connection. The network is controlled and access is provided to the internet from the Main Distribution Point (MDP) 22, which is a network point of presence (POP) whereby the wireless network is linked to the internet and this serves as the management, alarm, and control site for the network. Additional connectivity is provided to customers via Metropolitan Distribution Points 24, located throughout the network coverage area. These are network access points where customers initially access the network. The current art uses radio transceivers 26 that are predominately either DSSS or FHSS protocol units provided by several prevalent manufacturers. Typically Omni-directional antennas 28 are used to broadcast and receive signals to and from customer sites 30. At the customer locations, a radio transceiver and directional antenna combination completes the link thereby allowing customer access to and from the internet.

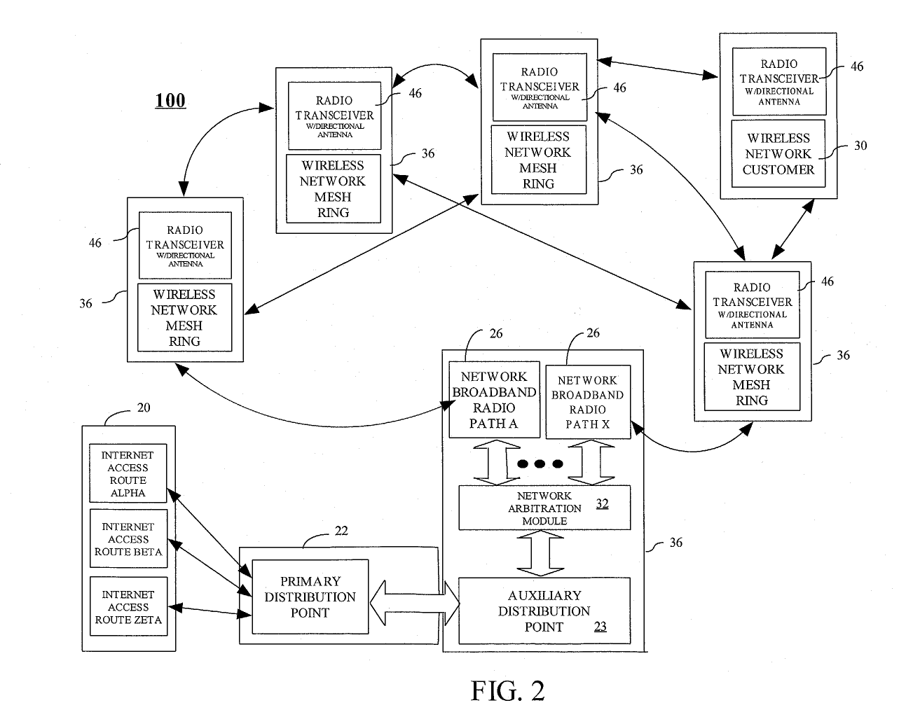

FIG. 2 comprises illustrates a network 100 with a block diagram detailing the flow of the present invention providing broadband internet and IP data access to and from the network source with the inclusion of dynamic traffic load sharing and dynamic load balancing scheme which visually depicts the advantage over the prior art. The network 100 preferably includes a network information source 20 such as the internet traffic source shown. The purpose of the wireless network 100 is to provide broadband connectivity between a plurality of customers 30 located at disparate geographical points to the internet 20 via a wireless connection. The network is controlled and access is provided to the internet from the Primary Distribution Point (PDP) 22, which is the network point of presence (POP) whereby the wireless network is routed to the internet and the PDP site provides network management, as well as, alarm and control of the network. Connectivity is provided to customers via Auxiliary Distribution Points (ADP) 23 located throughout the network coverage area. These sites serve as hubs for a mesh ring network such as a metro mesh ring network and they are also network access points where customers initially access the network via radio transceivers and antennas.

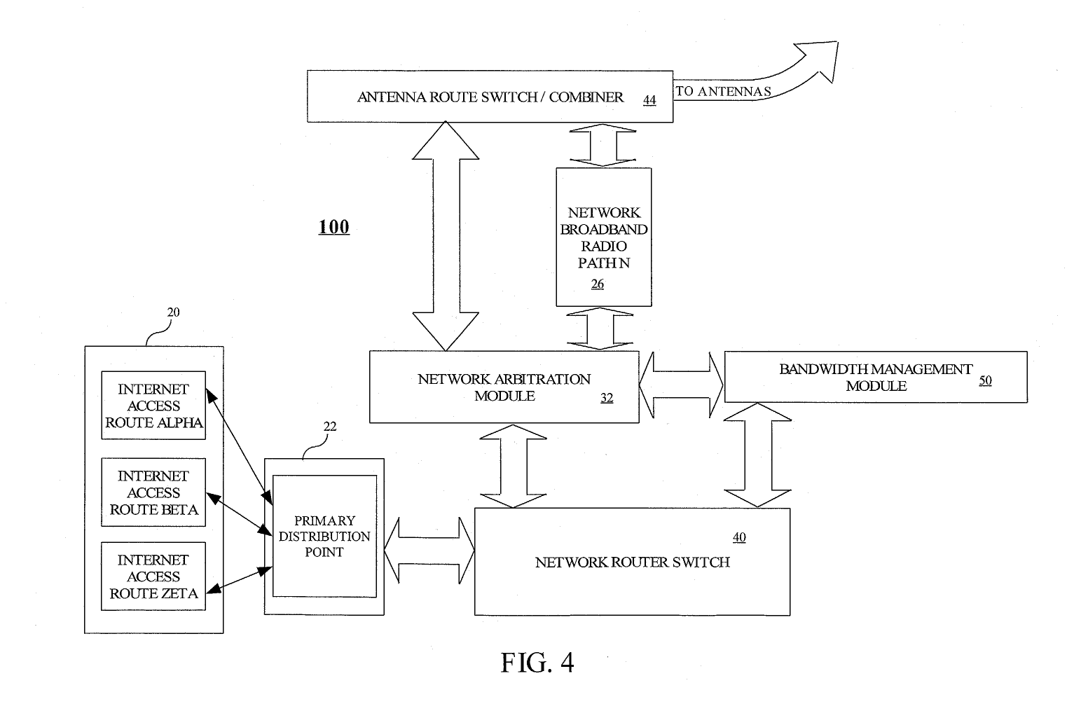

The present invention routes network traffic through the network via a Network Arbitration Module (NAM) 32 which measures and monitors the network traffic load and demand, as well as other parameters that are used to determine the best route to assign traffic through. The NAM 32 is used to maximize network efficiency and limit network latency by determining which of the associated routes are the least busy or not available at all, in which case the NAM 32 routes around the problem and issues a network alarm. The NAM 32 measures network traffic, as well as, RF radio transceiver signal strength and throughput data rates and uses this information to switch the traffic accordingly to the most efficient path. (see FIG. 4 described below).

The present invention also uses radio transceivers 26 (for path A to X) to create a communication backhaul network module 36 (which can be 8 mbps to 1 gigabit per second of throughout as needed for example or any other specified throughput), and further serves to link the ADP 23 and the customer site 30. Radio transceivers 26 at the main communication backhaul network module 36 as well as transceivers 46 at other modules 36 in the mesh ring network and at the customer site 30, can be a mix of DSSS and FHSS protocol units as provided by several prevalent manufactures. Each communication backhaul network module 36 serves as an ADP that is connected to one or more radio transceivers (24 or 26), used for sending and receiving RF transmissions, which provides connectivity to the customer sites 30. In FIG. 2, the ADP 23 is connected to the radio transceivers 26. In a preferred embodiment, the radio transceivers 26 and 46 can be general-purpose microwave units employing FHSS or DSSS protocols for sending and receiving information to and form the ADP. The radio transceivers 26 communicate through an RF link via antennas (not shown) via the modules 36 serving as ADPs to the radio transceivers 46 at the customer sites 30. The radio transceivers 46 preferably include directional antennas used to broadcast and receive signals across the network and to and from customer sites 30 which completes the link thereby allowing customer access to the internet. Those skilled in the art will realize that the network includes a plurality of ADP sites located throughout the coverage area, where each ADP acts as a mesh network hub and or a customer network access point. In one embodiment, the range from each ADP to a customer site can be up to 10 miles. In another embodiment, ADP's can be distributed at approximately 1 to 10 mile intervals to serve as repeaters to reach outlying customer sites or to route around obstructions, depending on topology, morphology, environment, etc. The entire wireless broadband access network can operate on any viable RF frequency. Radio transceiver and microwave equipment are available from any number of companies including, but not limited to, Alvarion, Western Multiplex, Proxim, Cisco, Lucent Technologies, Wireless Inc., and Nokia.

The modules 36 serving as ADPs have several functions. They receive RF and convert it to Ethernet for local distribution, and can receive Ethernet and convert it to RF and then transmits it to the PDP 22. The module 36 can route information to another module 36 serving as an ADP without going through the PDP 22, and can receive RF and regenerate it forward to the next ADP for processing acting as a repeater.

In one embodiment, each customer site 30 has a dedicated radio transceiver and antenna (46) and is served by a dedicated radio transceiver 26 at the ADP (36). In another embodiment, a single radio transceiver 26 can serve more than one customer operating through the same antenna by employing a header in the data packet that indicates the intended customer recipient, via one radio transceiver and antenna (46) at the same physical location or customer site 30.

Representative customers for receiving service via the wireless broadband access network in FIG. 2 include Commercial carriers, Business (Enterprise to small), Government, Schools, and Homes, Home offices and Mobile users.

If a customer site includes a LAN to which its employees or agents are connected, the ADP (36) connects to the radio transceiver and antenna (46) which then connects to the LAN server at that customer site. Individual users gain access to their LAN which then transmits a signal to the ADP (36) when access is needed to and from the Internet or wired network 20.

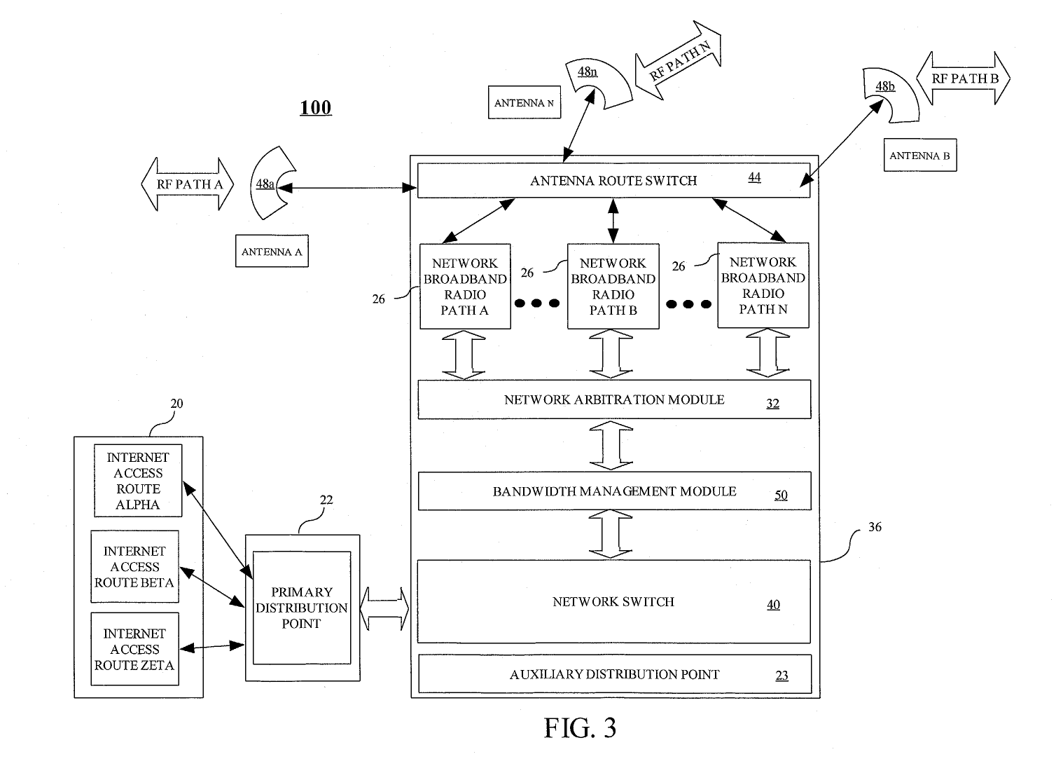

FIG. 3 depicts the network 100 again in the form of a block diagram detailing the flow of the present invention and in particular the function of the Network Arbitration Module in accordance with the teachings of the present invention.

The Network Arbitration Module (NAM) 32 is used to communicate with other network devices and make routing decisions based on the information that it receives. The primary role of the NAM 32 is to route traffic via the least busy, fastest path to and from the customer. In order to do this, the NAM 32 must interact with the network switch (NS) 40 which manages the network traffic in, out and through the wireless network. From the NS 40, the NAM 32 can learn the status of the network traffic and how busy each individual route is. For example, the NS 40 can constantly measure the status and usage of the Internet sources (20) in and out of the network, and the NAM 32 can use this information to determine how to route traffic around and through the wireless network.

The NAM 32 can also coordinate with the RF path to know which routes are the best for least time to customer consideration. The Antenna Route Switch (ARS) 44 preferably communicates with the RF equipment constantly in its path (via antennas 48a-n to remote transceivers or via other wired or wireless link to network broadband radios 26) and determines the status of the paths and what percentage of capacity they are. The NAM 32 uses this information to route information in, out and around the wireless network. For example, if in FIG. 3, RF path A is too busy or fails, the ARS 44 relays this information to the NAM 32 where it determines an alternative path until RF path A is usable and concurrently generates an alarm state. The NAM 32 also poles the radio transceivers 26, 46, in the network to ensure they are operating and operating efficiently. Should a radio transceiver (26 or 46) be inoperative or consistently reporting errors, the NAM 32 would route accordingly and issue a trouble ticket to network operations for repair or replacement.

In order to operate the network at optimum efficiency, a Bandwidth Management Module 50 is used to manage, measure and track the bandwidth in, out and around the network. The BMM 50 manages all data throughout the network including IP addresses and individual the medium access control (MAC) addresses on each PC/Server at each customer site. The BMM 50 is used to assign the contracted amount of throughput to an individual customer's PC MAC address, which also ensures that the customer is not receiving more throughput than they are paying for, and lastly, it helps to ensure that the link is being utilized optimally and that no one customer dominates the available bandwidth. The NAM 32 coordinates with the BMM 50 to learn how much bandwidth is needed on each route based on the average usage profile to the customers in a particular routing area.

FIG. 4 is another block diagram depicting the network 100 and detailing the flow and interaction of the Network Arbitration Module (NAM) with other key components in the network as well as the dynamic input and output description. The NAM 32 interacts and utilizes key information from other network components as shown. The BMM 50 generally measures and monitors network traffic load and demand. With respect to the BMM 50, the NAM 32 coordinates with the BMM 50 to learn how much bandwidth is needed on each route based on the average usage profile to the customers in a particular routing area and measures this against the aggregate available bandwidth. The NAM 32 then stores this information in its decision routing matrix for processing and route switching consideration from which it determines if the routes are being utilized to their maximum efficiency. The NAM 32 weighs the capacity of each network route against its actual load factor on a particular route and makes decisions on how to most efficiently haul the traffic over the available pipes. If it is determined that a route is approaching its maximum bandwidth capacity and there are no other paths to offload capacity to, it will generate an alarm.

From an output perspective of the NAM 32 to the BMM 50, if a route should become unavailable or unusable, the NAM 32 will know this from its inputs and information learned from the decision route matrix, and will inform or control the BMM 50 to throttle down or disable that path until it is once again viable. If a route should begin to exceed capacity and no alternative offload routes are available, then the NAM 32 will issue an order to the BMM 50 to throttle back users based on the type and importance of communication. For example, a matrix of the type of user and their content can be throttled down to allow for more available bandwidth throughput. Low level users and their low priorities like email and FTP activities would be the first to be throttled.

From an input perspective of the NAM 32 from the Network Switch (NS) 40, the NAM [32] learns the status of the network traffic and how busy each individual route is. For example, the NS 40 constantly measures the status and usage of the Internet sources (20) in and out of the network, and the NAM 32 uses this information to determine how to route traffic around and through the wireless network depicted in FIG. 2. The NAM 32 tracks this information in real time in its decision routing matrix and then coordinates with other devices to make the network more efficient.

From an output perspective to the NS 40, the NAM 32 uses the information in its decision routing matrix tables and coordinates with the NS 40. The NAM 32 will poll the NS 40 and it can issue commands to change network status.

The radio transceivers 26 and 46 can monitor the RF radio transceiver signal strength (RSSI), bit error rate, throughput, and other parameters that affect latency. From an input perspective the NAM 32 polls the radio transceivers 26 and 46 in the network 100 to ensure they are operating and operating efficiently. Should a radio transceiver be inoperative or consistently reporting errors, the NAM 32 would route accordingly and issue a trouble ticket to network operations for repair or replacement. The NAM 32 can measure bit error rate (BER) and RSSI (radio signal strength indication) to determine the RF efficiency of the radio transceivers 26 and 46. Both the data and RF status of each radio transceiver 26 and 46 can be tracked in decision routing matrix tables for example. From an output perspective to the radio transceivers 26 and 46, the NAM 32 communicates with the radio transceivers 26 and 46 for troubleshooting purposes. If a radio transceiver drops in BER or RSSI, the NAM can a) issue an alarm and begin to reroute the traffic away from the route in question; or b) if the radio transceiver 26 or 46 is responding, it can issue diagnostics and check by putting sample data across the link in question to determine the nature of the problem to determine if the nature of the problem is due to data or the radio frequency connection; or c) issue a radio reset to both radio transceivers 26 and 46 and retest; or d) if the radio transceiver is not responding, it can issue a major outage alarm, or e) wait for an all clear status to put the route back in the network.

From an input perspective from the ARS 44, the NAM 32 must also coordinate with the RF path to know that the routes are operating at acceptable levels of efficiency so that it can make the appropriate routing decisions. The Antenna Route Switch ARS 44 can constantly communicate with the RF equipment in its path and determine the status of the paths and their levels of efficiency. The ARS 44 can measure BER and RSSI to determine the relative RF and Data bandwidth efficiency of each path and then submit this data to the NAM 32 where it is put in the decision routing matrix for consideration. The NAM 32 uses this information to route information in, out and around the wireless network. From an output perspective to the ARS 44, the NAM 32 communicates with the ARS 44 to dynamically check/test the RF status of a particular path. Also for maintenance, the NAM 32 will issue an order for the ARS 44 to disable alarms and testing on link equipment that is being repaired or maintained.

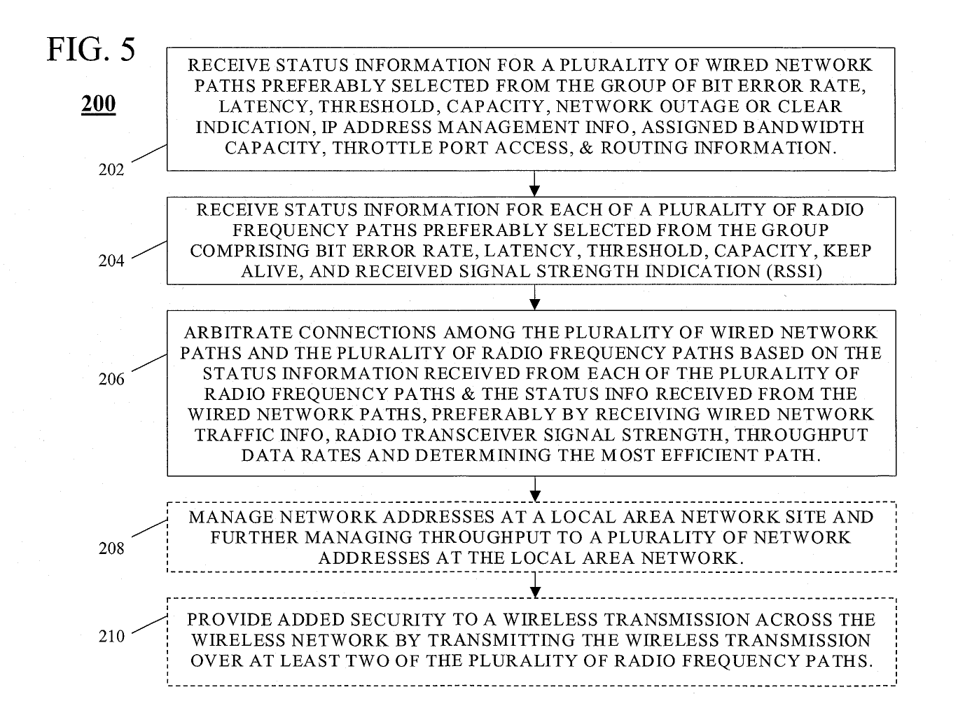

Referring to FIG. 5, a flow chart illustrates a method 200 of dynamic load sharing and balancing for a wireless network coupled to a wired network in accordance with the present invention. The method 200 can comprise the step 202 of receiving status information for a plurality of wired network paths preferably selected from the group of bit error rate, latency, threshold, capacity, network outage or clear indication, internet protocol address management information, assigned bandwidth capacity, throttle port access, and routing information. The method can further comprise the step 204 of receiving status information for each of a plurality of radio frequency paths preferably selected from the group comprising bit error rate, latency, threshold, capacity, keep alive, and received signal strength indication (RSSI). The method can further comprise the step 206 of arbitrating connections among the plurality of wired network paths and the plurality of radio frequency paths based on the status information received from each of the plurality of radio frequency paths and the status information received from the wired network paths, preferably by receiving wired network traffic information, radio transceiver signal strength, throughput data rates and determining the most efficient path. Optionally, the method 200 can include the step 208 of managing network addresses at a local area network site and further managing throughput to a plurality of network addresses at the local area network or the step 210 of providing added security to a wireless transmission across the wireless network by transmitting the wireless transmission over at least two of the plurality of radio frequency paths. It should be noted that although the present invention contemplates and can utilize the inherent security aspects of spread spectrum wireless protocols, the present invention adds additional security by using multiple diverse paths which add another layer of security against tampering and electronic eavesdropping.

While the invention has been described with reference to a particular embodiment, it will be understood by those skilled in the art that various changes may be made and equivalent elements may be substituted for elements thereof without departing from the scope of the present invention. For example, the present invention could be applicable in a LAN, WAN, or MAN scenario or in other networks that could use arbitration among various communication links. In addition, modifications may be made to adapt a particular situation more material to the teachings of the present invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A network arbitration module for directing data traffic in a wireless network and a wired network, comprising:
at least a first input for receiving status information from at least a first network broadband radio, wherein the status information is selected from the group comprising bit error rate, latency, threshold, capacity, and received signal strength indication (RSSI);
at least a second input for receiving status information from a wired network router, wherein the status information is selected from the group comprising of bit error rate, latency, threshold, capacity, network outage or clear indication, internet protocol address management information, assigned bandwidth capacity, throttle port access, and routing information; and
a processor programmed to:
control an antenna route switch for coupling at least the first network broadband radio among a plurality of wireless network paths.

2. The network arbitration module of claim 1, wherein the processor is further programmed to update other network arbitration modules coupled to the network arbitration module with information from at least the second input.

3. The network arbitration module of claim 1, wherein the processor is further programmed to update other network arbitration modules coupled to the network arbitration module with information from at least the first input and at least the second input.

4. A network arbitration module for directing data traffic in a wireless network and a wired network, comprising:
at least a first input for receiving status information from a plurality of broadband radio paths, wherein the status information for each radio path is selected from the group comprising bit error rate, latency, threshold, capacity, and received signal strength indication (RSSI);
at least a second input for receiving status information from a wired network router, wherein the status information is selected from the group of comprising bit error rate, latency, threshold, capacity, network outage or clear indication, internet protocol address management information, assigned bandwidth capacity, throttle port access, and routing information;
a processor programmed to:
control an antenna route switch for coupling at least a first network broadband radio among the plurality of broadband radio paths forming a plurality of wireless network paths.

5. A dynamic load sharing and balancing system for a wireless network coupled to a wired network comprising:
a network router for coupling a plurality of wired network paths and for providing status information for the plurality of wired network paths;
a plurality of broadband radios forming a plurality of radio frequency paths and for providing status information for each of the plurality of radio frequency paths; and
a network arbitration module for receiving the status information from the plurality of wired network paths and for receiving the status information from at least one of the plurality of radio frequency paths and for directing traffic among the plurality of radio frequency paths based on the status information from the wired network paths and the plurality of radio frequency paths.

6. The system of claim 5, wherein the status information for the plurality of wired network path is selected from the group of status information comprising bit error rate, latency, threshold, capacity, network outage or clear indication, internet protocol address management information, assigned bandwidth capacity, throttle port access, and routing information.

7. The system of claim 6, wherein the system further comprises a bandwidth management module coupled to the network arbitration module and the network router, wherein the bandwidth management module assigns bandwidth capacity and throttles port access for a plurality of assigned IP addresses at a local area network.

8. The system of claim 5, wherein the status information for the plurality of radio frequency paths is selected from the group of status information comprising bit error rate, latency, threshold, capacity, keep alive, and received signal strength indication (RSSI).

9. The system of claim 5, wherein the network router further comprises a bandwidth management module for assigning the aggregate bandwidth among the plurality of wired network paths linked to the plurality of radio frequency paths.

10. The system of claim 5, wherein at least a portion of the plurality of broadband radios are radio transceivers forming a wireless network mesh ring.

11. The system of claim 5, wherein at least a portion of the plurality of broadband radios use frequency hopped spread spectrum modulation techniques.

12. The system of claim 5, wherein at least a portion of the plurality of broadband radios used direct sequence spread spectrum techniques.

13. The system of claim 5, wherein the network arbitration module receives the status information from each of the plurality of radio frequency paths and directs traffic among the plurality of radio frequency paths based on the status information from the wired network paths and each of the plurality of radio frequency paths.

14. The system of claim 5, wherein the system further comprises means for measuring latency on each of the plurality of wired network paths and on each of the plurality of radio frequency paths, wherein the means for measuring provides status information.

15. A method of dynamic load sharing and balancing for a wireless network coupled to a wired network comprising the steps of:
receiving status information for a plurality of wired network paths;
receiving status information for each of a plurality of radio frequency paths; and
arbitrating connections among the plurality of wired network paths and the plurality of radio frequency paths based on the status information received from each of the plurality of radio frequency paths and the status information received from the wired network paths.

16. The method of claim 15, wherein the step of receiving status information for a plurality of wired network paths comprises receiving status information selected from the group comprising bit error rate, latency, threshold, capacity, network outage or clear indication, internet protocol address management information, assigned bandwidth capacity, throttle port access, and routing information.

17. The method of claim 15, wherein the step of receiving status information for each of the plurality of radio frequency paths comprises receiving status information selected from the group comprising bit error rate, latency, threshold, capacity, keep alive, and received signal strength indication (RSSI).

18. The method of claim 15, wherein the step of arbitrating comprises receiving wired network traffic information, radio transceiver signal strength, throughput data rate and determining the most efficient path.

19. The method of claim 15, wherein the method further comprises the step of managing network addresses at a local area network site and further managing throughput to a plurality of network addresses at the local area network.

20. The method of claim 15, wherein the method further comprises the step of providing added security to a wireless transmission across the wireless network by transmitting the wireless transmission over at least two of the plurality of radio frequency paths.
